(19) United States
(12) Patent Application Publication
(10) Pub. No.: US 2006/0190619 A1
(43) Pub. Date: Aug. 24, 2006

(54) Web browser communication

(75) Inventors: Samuel S Tenembaum, Punta Del Este (UY); Ramiro Repetto, Buenos Aires (AR); Alberto Nakayama, Buenos Aires (AR); Manuel Caballero, Buenos Aires (AR)

Correspondence Address: DARBY & DARBY P.C., P. O. BOX 5257, NEW YORK, NY, 10150-5257, US

(73) Assignees: PORTO RANELLI, SA, PUNTA DEL ESTE (UY); PI TRUST, NEW YORK, NY (US)

(21) Appl. No.: 10/515,256

(22) PCT Filed: May 22, 2003
(86) PCT No.: PCT/US03/16317

§ 371 Date: Feb. 7, 2006

Related U.S. Application Data
(60) Provisional application No. 60/382,840, filed on May 22, 2002.

(51) Int. Cl. G06F 15/16

(52) U.S. Cl. 709/233

(57) ABSTRACT

The present invention relates to a method for sharing and transferring data between different web browser frames (1, 2) which are served from different domains. This makes it possible to outsource services that would not be possible otherwise, owning to security limitations imposed by the web browser (101). The interaction between frames (1, 2) allows for the development of various services and products, like chat tools, customized floating toolbars, navigation inside a frame, advertising and many others. By circumventing browser imposed limitations which prevent frames served from one domain from communicating with other frames served from a different domain, the invention makes it possible for services to be provided by third parties, and it also makes

### FIELD OF THE INVENTION

The present invention relates to a method for sharing and transferring data between different frames of a web browser which are served from different domains. This allows for the outsourcing of services that would not be possible otherwise, owing to security imposed limitations on the web browser.

### BACKGROUND OF THE INVENTION

Just as computer networks have gained widespread use in business, the Internet (one example of a computer network) has gained widespread use in virtually every aspect of our lives, owing primarily to the popularity of the worldwide web. The internet includes servers (computers), which offer electrical communication to client computers (operated by users) and other servers. The computers involved may range from mainframes to cellular telephones, and they may operate over any conceivable communication medium.

Most users connect to the Internet (or “surf the net”) through a personal computer running an operating system with a graphic user interface (GUI), such as one of the Windows® operating systems. A user communicates over the Internet using a program called a “browser” running on his computer, the two most popular ones being Internet Explorer and Netscape, although many other browsers are in common use. The browser receives files in a format known as HTML, which is a mark-up language that permits multimedia to be embedded within formatted and stylized text, and it displays “pages”, which may play sound and exhibit graphics and video. Various programming languages, such as JavaScript, are also available which permit executable code to be embedded in an HTML file and to run and to perform useful tasks when a browser presents the file to the user. Users of the Internet are therefore quite familiar with the browser as a vehicle for surfing the Internet, but those skilled in the art will appreciate that browsers are not limited to use on the Internet, but are now widely used for general communication on networks, including intranets.

In addressing security and privacy issues, web browsers have imposed limitations on the interaction between frames contained on a same page. Depending on the browser, its version and user defined parameters, the communication can be enabled or impaired. This prevents code in one browser frame from being manipulated from another frame, hence averting security breaches like password sniffing, content and advertising replacement, and unauthorized tampering with code by third parties.

However, such security measures also preclude legitimate applications from making use of such inter-frame interactions. One such application, included here for illustrative purposes (and not to be considered exclusive) is the contextual browser described in U.S. patent application Ser. No. 10/716,163, the content of which is incorporated herein by reference in its entirety. As described in the aforementioned patent application, the browser portion of a given web page (the toolbar contained in the upper frame) is limited to being served from the same domain as the page being viewed. If that limitation is not circumvented, certain browser engines will not be capable of enabling the interaction between frames.

If a web site wishes to outsource this type of application, or if an ASP wishes to offer it to its clients, it becomes desirable to serve parts of a page that are contained in different frames from diverse servers in diverse domains. To achieve this, the present invention relies on various triangulation techniques, depending on the capabilities of the various browsers on the market. This triangulation is done via a Messenger Agent, which can be programmed in a number of languages and using a number of technologies.

Additionally, an error trapping mechanism is built onto the system to detect situations in which the frame communication does not occur as expected.

In the example of the Contextual Browser, the error trapping can trigger a controlled deactivation process.

### BRIEF DESCRIPTION OF THE DRAWINGS

The foregoing brief description, as well as further objects, features, and advantages of the present invention will be understood more completely from the following detailed description of a presently preferred embodiment, with reference being had to the accompanying drawing, in which:

FIG. 1 is a functional block diagram illustrating the layout of a preferred embodiment of a Contextual Browser in accordance with the invention;

FIG. 2 is a functional block diagram illustrating the illustrating a universal structure which may be incorporated in a web page to achieve inter-frame communication; and

FIGS. 3-5 are flow charts illustrating the processes utilized to achieve inter-frame communication with the universal structure of FIG. 2.

### DETAILED DESCRIPTION OF THE PREFERRED EMBODIMENT

The present invention circumvents inter-frame communication limitations imposed by web browsers by introducing an agent in the line of communication. This agent may be programmed in any of a number of possible ways. The preferred embodiment of the invention employs any of a variety of possible solutions, depending upon which web browser is employed.

For illustrative purposes, the Contextual Browser will be used to describe the operation of the invention. The Contextual Browser is made up of a single web page divided into upper and lower frames. The upper one contains the toolbar and the lower one the web page being displayed. In order to enable the functionality of the Contextual Browser, certain code must be added to the page being viewed. This code retrieves instructions for the deployment of the two frames and the subsequent communication between them.

In this scenario, chosen to exemplify the operation of the invention, the upper frame, the toolbar, is served from one domain, while the web page, the content, is served from a different one. Both frames are contained within a frameset, with which both frames can communicate. All communications that cannot occur directly are routed through this frameset.

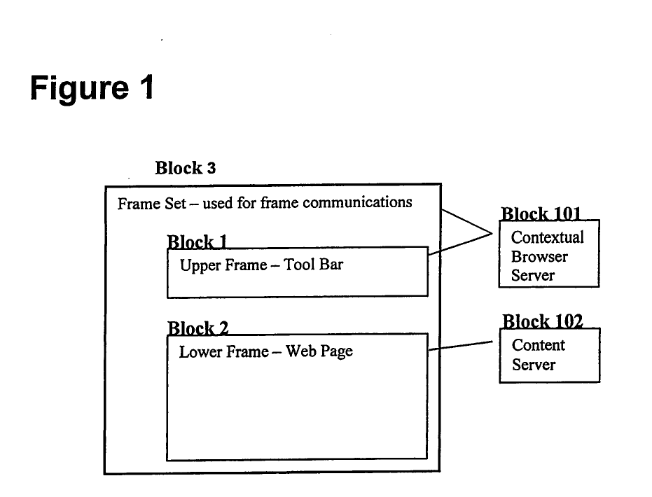

FIG. 1 is a functional block diagram illustrating the layout of a preferred embodiment for a Contextual Browser. Block 1 is the upper frame, containing the toolbar, which is served from the Contextual Browser Provider Server (Block 101). Block 2 is the lower frame, containing the content page, including the Contextual Browser enabling code, which is served by the Content Provider Server (Block 102). Block 3 is the frameset containing both frames.

Once the Contextual Browser has been deployed, communication between frames is necessary for its operation. Such exchange occurs in a number of ways depending on the platform.

Definitions:

UF→Upper Frame
LF→Lower Frame
FS→Frame Set
TARGET attribute→The target attribute indicates the intended recipient of a command or a message. When the Upper Frame “talks” with the other frame, it should set the “Target” as the destination frame which will receive the message. In fact, if the Upper frame sets the Target to_Top, it will be “speaking” to the frame set, if the Upper Frame sets the Target to “lower”, it will be speaking to the Lower Frame directly.
Event→An event is an action triggered by the user or by the Browser itself when specific tasks are executed. For example, the ONMOUSEOVER event is triggered by the user when he moves the mouse over an object. The ONLOAD event is triggered by the Browser when all the objects on a page have been loaded. When an event is triggered it can be “trapped” and any code associated with that event can be executed.

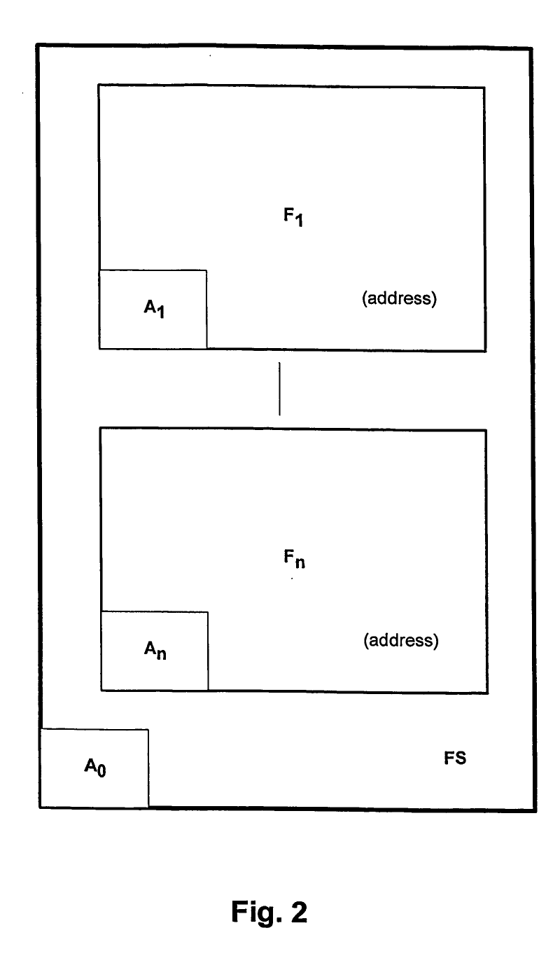

FIG. 2 illustrates a structure for use in an internet web page to permit intercommunication among a plurality of frames F₁ . . . F_{N}. The frames are located within a frame set FS and each frame has a unique address. An executable program referred to as a “messenger agent” exists as a file A₀ in the frame set FS and as files A₁ . . . A_{N}, in frames F₁ . . . F_{N}, respectively.

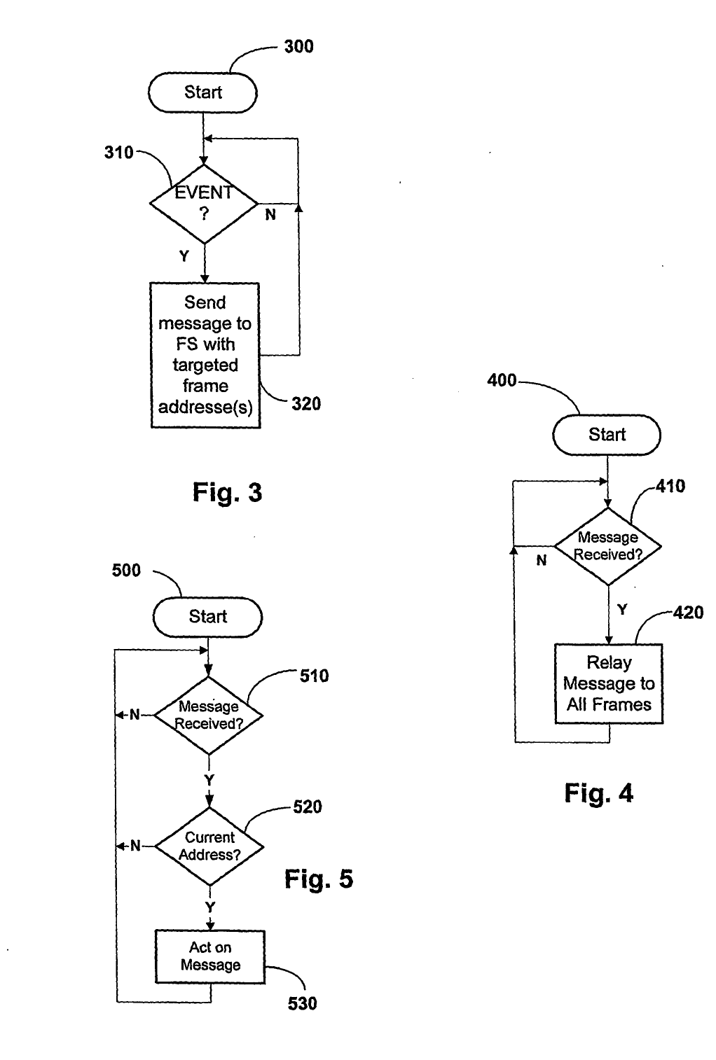

FIG. 3 is a flowchart illustrating a process performed by the messenger subprograms A₁-A_{N}. The process starts at block 300, and at block 310, the occurrence of an event is awaited, at which time control transfers to block 320. At block 320, the frame in which the program resides sends a message to the frame set FS which contains the addresses of any targeted frame(s). Control is then returned to block 310.

FIG. 4 illustrates a process performed by messenger agent subprogram A₀. The process starts at block 400, and at block 410, receiving a message is awaited. When the message is received, control transfers to block 420. At block 420, the frame set transfers or relays the message to all of the frames, preferably after storing it, and control transfers to block 410.

FIG. 5 illustrates the process performed in a frame (the current frame) when it receives a message relayed from the frame set. At block 510, the receipt of a message is awaited, and when the message is received, control is transferred to block 520. At block 520, a test is performed to determine whether the received message contains the current address (i.e. the address of the current frame) and, if so, control is transferred to block 530. If a received message does not contain the current address, control returns to block 510. At block 530, a message with the address of the current frame has been received, and the current frame acts on that message.

The processes of FIGS. 3-5 together define a process for “universal” communication among frames on a web browser page. This process is universal in the sense that it is usable regardless of the technology present in the user's computer. When a frame (the transmitting frame) wishes to communicate with one or more other frames (a receiving frame), the transmitting frame would utilize the process of FIG. 3 to generate a message with the address of a receiving frame when an event occurs, and it would send this message to the frame set. Utilizing the process of FIG. 4, the frame set will receive this message and relay it to all of the frames. Each frame will receive this message and, utilizing the process of FIG. 5, will determine whether the message was addressed to it, and it will act accordingly.

In order to exemplify the present invention, it will now be described how a page with an upper frame (UF) and lower frame (LF) within a frame set (FS) would communicate with each other when various technologies are present at the user's computer.
1. Windows—Internet Explorer 4 or newer without Macromedia Flash installed.
   a. LF to UF communication: the universal method is utilized (N=2)
   b.
      i. Alternative 1 UF to LF communication: the universal method is utilized (N=2).
      ii. Alternative 2 UF to LF communication: UF communicates directly with LF by defining the TARGET attribute available in HTML to make LF the target.
2. Windows—Internet Explorer 4 or newer with Flash installed.
   a. UF to LF communication: The conventional Flash function GET_URL indicates the action and the destination frame. An Action is a call to a function defined on the destination frame. Functions are contained in a JavaScript file inside the Contextual Browser enabled web page. Alternately, the SetVariable Flash function could be used the same way.
   b. LF to UF communication: the universal method is utilized (N=2).
3. Windows Netscape 4.x with or without Flash
   a. Any event, on either frame, triggers a communication with the other frame: the event calls a function in the other frame with parameters based on the event. There are no security issues, except on version 4.5.
4. Macintosh Explorer 5.x with Flash
   a. The logic is exactly as with item 2 (Internet Explorer 4 with Flash), but the specific code is different.
5. Macintosh Explorer 5.x without Flash
   a. The logic is exactly the same as with item 1 (Internet Explorer 4 without Flash), but the specific code is different.
6. Macintosh Netscape 4.x
   a. Any event, on either frame, triggers a communication with the other frame: the event calls a function in the other frame with parameters based on the event. There are no security issues.
7. Linux Netscape
   a. Any event, on either frame, triggers a communication with the other frame: the event calls a function in the other frame with parameters based on the event. There are no security issues.
8. AOL
   a. The same as item 2 (Internet Explorer with Flash)
      Error Trapping Mechanism

In addition to enabling the communication between frames served from diverse sources, the current invention includes a mechanism to catch situations in which the system malfunctions, allowing for the triggering of alternate flows.

This mechanism works as follows: When a frame changes, either by order of the other or by user interaction (click), it informs the other frame that a change has initiated. The other frame then expects another message from the new page being loaded. If the message never arrives, then the remaining active frame deactivates and triggers an alternate procedure. In the Contextual Browser example, the alternate process is the deactivation of the Contextual Browser.

### DESCRIPTION OF PREFERRED EXECUTABLE CODE

In this section, the PRINT function in the Contextual Browser is used to exemplify the communication from frame to frame. The communication is originated when the user clicks on the PRINT button located on the UPPER FRAME to print the contents of the LOWER FRAME.

On click, the following call is made:

writeVar(“print”);
/----****----
function writeVar(theAction)
{
accion=theAction;
mensaje=readVar( );
if (mensaje==“NULL” | | accion.substring(1,accion.length)==mensaje ||
accion.substring(1,accion.length)==mensaje.substring(0,4) ||
mensaje.substring(0,4)==“”)

{

top.status=accion;

}
else
{

window.setTimeout(‘writeVar(“‘+accion+’”)’,100);

}

}
/----****----

This call changes the status of the frameset. Every 100 milliseconds, the frameset checks for any status changes, meaning, if any messages have arrived. If the answer is yes, then the message is relayed to each frame contained in the frameset through a method consisting of changing the window name.

/----****----
function estatus( )
{
if (window.status!=mensajeact)

{
mensajeact=window.status;
window.topFrame.name=mensajeact;
window.DATA.name=mensajeact+‘_’;
}

window.setTimeout(‘estatus( )’,100);
}
/----****----

Each page checks whether any changes have occured in the window name. If there are any, such change is recognized as the message to be received. Once the message is received, the page checks whether it has to perform any actions. In this sample, the message is “print_”

/----****----
Function mensajero( )
{
mensaje=readVar( );
if (mensaje && mensaje!=mensajeact)

{

mensajeact=mensaje;
switch (mensajeact)

{

case “print_”:
{

prePrint( );
writeNullVar( );
break;

}

window.setTimeout(‘mensajero( )’,180);
}
/----****----

In the above example, the messenger function receives the word “print_”, makes a call to the preprint function, which will print the page. The communication circuit is finished.

Although a preferred embodiment of the invention has been disclosed for illustrative purposes, those skilled in the art will appreciate that many additions, modifications and substitutions are possible, without departing from the scope and spirit of the invention. For example, the communication between the Flash program and HTML can be done using the common GET_URL method from Flash or using the SetVariable method.

1. A method for transferring data between frames in a page of a web browser running on a user's computer, the method comprising the steps of:
providing the frames within a common frame set;
associating a unique address with each frame; and
communicating between the frames in a manner determined by the technology present in the user's computer.

2. The method of claim 1 utilizing a browser using HTML, a first frame communicating with a second frame by defining the HTML TARGET attribute to make the second frame the target.

3. The method of claim 2 utilized in a user's computer which has the Flash program installed, further comprising the step of including a function in a JavaScript file in the web page, a first frame communicating with a second frame by using the GET_URL or the SetVariable Flash function, with a call to the function in the JavaScript file as the action and the second frame as the designated frame.

4. The method of claim 1 wherein a first frame communicates with a second frame as a result of an event in the first frame calling a function in the second frame.

5. A method for transferring data between a plurality of frames of a web browser running on a user's computer, said method comprising the steps of:
providing the frames within a common frame set;
associating a unique address with each frame; and
communicating from a first frame to a second frame by sending from the first frame to the frame set a message addressed to the second frame, transmitting the message from the frame set both frames, and accepting the message at the second frame when the message has the second frame's address.

6. A structure for a page of a web browser running on a user's computer, comprising:
a frame set;
a plurality of frames within the frame set, each frame having a unique address associated with it; and
executable code which achieves communication between the frames in a manner determined by the technology present in the user's computer.

7. The structure of claim 6 utilized a browser using HTML, the executable code including a subprogram provided in a first frame communicating with a second frame, the subprogram defining the HTML TARGET attribute to make the second frame the target.

8. The structure of claim 7 utilized in a user's computer which has the Flash program installed, the executable code including a function in a JavaScript file in the web page, and a subprogram in a first frame communicating with a second frame which uses the GET_URL or the SetVariable Flash function, with a call to the function in the JavaScript file as the action and the second frame as the designated frame.

9. The structure of claim 8 wherein the executable code includes a subprogram in a first frame responsive to the occurrence of an event to call a function in a second frame, to achieve communication from the first to the second frames upon the occurrence of an event.

10. A structure for a page of a web browser running on a user's computer, comprising:
a frame set;
a plurality of frames within the frame set, each frame having a unique address associated with it; and
executable code including a subprogram in a first frame which transmits from the first frame to the frame set a message addressed to a second frame, a subprogram in the frame set which transmits the message from the frame set to both frames, and a subprogram in the second frame which accepts the message at the second frame when the message has the second frame's address.

11. The method of claim 1 utilized in a user's computer which has the Flash program installed, further comprising the step of including a function in a JavaScript file in the web page, a first frame communicating with a second frame by using the GET_URL or the SetVariable Flash function, with a call to the function in the JavaScript file as the action and the second frame as the designated frame.

12. The structure of any of claim 6 utilized in a user's computer which has the Flash program installed, the executable code including a function in a JavaScript file in the web page, and a subprogram in a first frame communicating with a second frame which uses the GET_URL or the SetVariable Flash function, with a call to the function in the JavaScript file as the action and the second frame as the designated frame.

13. The structure of claim 12 wherein the executable code includes a subprogram in a first frame responsive to the occurrence of an event to call a function in a second frame, to achieve communication from the first to the second frames upon the occurrence of an event.

14. The structure of claim 7 wherein the executable code includes a subprogram in a first frame responsive to the occurrence of an event to call a function in a second frame, to achieve communication from the first to the second frames upon the occurrence of an event.

15. The structure of claim 6 wherein the executable code includes a subprogram in a first frame responsive to the occurrence of an event to call a function in a second frame, to achieve communication from the first to the second frames upon the occurrence of an event.
